(19) United States
(12) Patent Application Publication
(10) Pub. No.: US 2026/0220752 A1
(43) Pub. Date: Jul. 30, 2026

(54) RAPID ROCK PETROPHYSICAL QUALITY ANALYSIS WITH ELASTOMERIC SENSOR BASED IMAGES

(71) Applicant: Halliburton Energy Services, Inc., Houston, TX (US)

(72) Inventors: Wei SHAO, Houston, TX (US); Songhua Chen, Liberty Hill, TX (US); Gabriela Singer, Houston, TX (US)

(73) Assignee: Halliburton Energy Services, Inc., Houston, TX (US)

(21) Appl. No.: 19/041,902

(22) Filed: Jan. 30, 2025

(51) Int. Cl. G06T 7/00; G06T 5/20; G06T 5/50; G06T 5/70; G06T 7/11; G06T 7/136

(52) U.S. Cl. CPC G06T 7/0002; G06T 5/20; G06T 5/50; G06T 5/70; G06T 7/11; G06T 7/136; G06T 2207/10028; G06T 2207/20221; G06T 2207/30181

(57) ABSTRACT

Aspects of the subject technology relate to systems, methods, and computer-readable media for identifying petrophysical parameters of a wellbore or wellbore derived samples. An elastomeric sensing device may be used to collect data from a surface of a sample. This may include pressing a sensing portion of the elastomeric sensing device onto a selected surface of the sample. Images of the surface of the sample may be acquired, and a combination of filtering techniques and segmentation techniques may be used to identify the sizes of pores or pore aspect ratios of the sample when the petrophysical parameters of the wellbore or the wellbore derived samples are identified.

### FIELD OF THE DISCLOSURE

The present disclosure pertains to identifying petrophysical properties of a core sample. More specifically, the present disclosure relates to determining the petrophysical properties of the core sample based on images of a surface of the core sample captured by an elastomeric sensing device.

### BACKGROUND

Wellbores are drilled into the Earth such that various substances can be extracted from or provided to underground subterranean strata. For example, wellbores are drilled such that oil, natural gas, brine, or water can be extracted. In some instances, materials such as hydraulic fracturing fluids or carbon dioxide are injected into subterranean strata either for the purpose of increasing yield from a well or for sequestering carbon dioxide underground. Whether a particular wellbore is developed to extract substances or inject substances into subterranean strata, holes in rocks of the strata affect how fluids flow through subterranean strata. Sizes of these holes and the density of hole distribution in subterranean strata affect how fast fluids migrate through the subterranean strata. Petrophysical properties like porosity and permeability can be used to identify how fast particular fluids are likely to flow through subterranean strata.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A is a schematic view of a wellbore operating environment in which a formation sample may be obtained, in accordance with various aspects of the subject technology.

FIG. 1B is a schematic view of a wellbore operating environment in which formation samples (e.g., sidewall cores) can be obtained, in accordance with various aspects of the subject technology.

FIG. 2 illustrates a system that may collect images of a core sample, perform evaluations on those collected images, and make determinations regarding properties of the core sample based on the evaluations of the collected images, in accordance with various aspects of the subject technology.

FIG. 3 illustrates actions that may be performed on images acquired by an elastomeric sensing device, in accordance with various aspects of the subject technology.

FIG. 4 illustrates the results of applying Gaussian filtering functions with different values of sigma on a set of image data, in accordance with various aspects of the subject technology

FIG. 5 illustrates a set of raw images and a set of light-adjusted images generated according to methods of the present disclosure, in accordance with various aspects of the subject technology

FIG. 6 illustrates the results of four different segmentation techniques applied to a set of image data, in accordance with various aspects of the subject technology

FIG. 7 illustrates how an image generated using one segmentation technique may more accurately represent pores of a sample than an image generated using another segmentation technique, in accordance with various aspects of the subject technology.

FIG. 8 illustrates graphs of four sets of data (e.g., pore size distributions) generated by application of a different segmentation technique on a set of image data of a sample, FIG. 8 also includes a graph of NMR T2 distribution time data of the sample, in accordance with various aspects of the subject technology

FIG. 9 illustrates bounding boxes drawn around specific pore spaces that may be used to identify aspect ratios of those pore spaces, in accordance with various aspects of the subject technology

FIG. 10 includes graphs of histograms of pore space aspect ratios derived using different image segmentation techniques, in accordance with various aspects of the subject technology

FIG. 11 illustrates an example computing device architecture which can be employed to perform various steps, methods, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Described herein are systems, apparatuses, processes (also referred to as methods), and computer-readable media (collectively referred to as “systems and techniques”) for evaluating rock samples of subterranean rock formations to identify how operations of one or more wellbores may be managed efficiently and effectively. Subterranean rock formations in the Earth and their associated properties may be investigated for a variety of purposes that include yet are not limited to the planning and development of wellbore sites, drilling, production management, hydraulic fracturing, and carbon sequestration. Such evaluations may be performed when a wellbore is drilled, after a wellbore is drilled, during a production process, or during a hydraulic fracturing process. One way to evaluate subterranean formations involves extracting samples from underground formations using wellbore equipment. One type of wellbore equipment used to extract core samples from Earth formations includes a drill bit that has a hollow space surrounded by cutting surfaces of the drill bit. As the drill bit penetrates the Earth, a cylinder of formation material is deposited in the hollow space. Such a cylindrical shaped core is commonly referred to as a “whole core.” Additionally, or alternatively, core samples may be cut from a sidewall of a wellbore. A core sample that is extracted from the sidewall of a wellbore may be referred to as a “sidewall core.” Sidewall core samples may be extracted from the wellbore after the wellbore has been drilled.

Laboratory analysis may provide information regarding how best to operate one or more wellbores such that production goals may be met. One limitation to this approach is that performing laboratory analysis on core samples using conventional techniques is time consuming and expensive.

Once core samples of any sort are cut out of the Earth formation, they may be transported to the surface where these extracted core samples may be tested using various laboratory tests. Detailed analysis of such core samples may allow data about Earth formations to be identified. This data may be used to develop and train computer models such that computer models can be used identify (within threshold levels) properties of new core samples without requiring that each new core sample to be tested in a laboratory. Because of this and after a training process has been completed, laboratory analysis of new core samples may only be performed as a quality control mechanism instead of as a primary data collection methodology. After a validation process has been performed, data collected by an elastomeric sensing device may be analyzed to identify petrophysical properties of a core sample, determinations may be made regarding how to manage the wellbore without need of performing time consuming laboratory tests.

Sets of data collected from these tests may be used to generate maps of geological formations. Multiple core samples may be extracted throughout the length of the wellbore and samples from multiple wells may also be collected and evaluated. As such, samples from one or more wellbores may be evaluated such that structures of different subterrain formations in the Earth may be mapped in two dimensions (2D), in three dimensions (3D), or in both 2D and 3D. As mentioned above, one limitation to relying upon conventional laboratory testing of core samples is related to the fact that laboratory testing of core samples is a lengthy process. Other limitations relate to the high cost of performing such laboratory tests and costs associated with delaying the development of a wellbore project while waiting for lab tests to be completed. For example, it could take many months to test rock samples extracted from a field that includes numerous wellbores. Waiting for such long period of time may simply make a particular project economically impractical. While operators could simply drill without relying upon core sample analysis, doing so could lead to limiting overall production from reservoirs that exist in the Earth.

Techniques consistent with the present disclosure may use a sensing apparatus to collect data that can be used to generate images of structures of a core sample. The imaging of such structures may allow topologies associated with strata located in the Earth to be identified, for example, based on computer filtering and/or modeling techniques. This is because computer models may be used to make evaluations such that petrophysical properties (e.g., porosity or permeability) of formations can be made more quickly and more inexpensively. New forms of artificial intelligence and machine learning may help identify types of rock and properties of core samples cut out of the Earth in near-real time.

While the disclosure so far has focused on performing analysis on core after those core samples have been extracted from a wellbore, in certain instances elastomeric sensing devices may be deployed downhole to capture images of subterranean rock surfaces. For example, an elastomeric imaging device may be pressed against the inner wall of a wellbore or the imaging device may be pressed against a side of a core sample while that core sample still remains downhole.

Numerous properties of the rock formations may be identified from core samples using computerized representations of sets of respective core samples. This may include, for example, identifying porosity, absolute permeability, capillary pressure, relative permeability, and other properties of a subterranean reservoir. Such analysis may also be directed toward identifying types and quantities of fluids distributed in permeable rock. Porosity is one example of a property that affects quantities of oil, water, volatile organic compounds (e.g., forms of hydrocarbons like N-Hexane that may be present in a liquid or gaseous form), or natural gas that may be present per unit volume of rock of a subterranean geological formation. Porosity may also affect how much carbon dioxide that can be sequestered in a subterranean formation.

By identifying the size and structure of pores in rock samples, the porosity of a subterranean geological formation may be identified. Images of samples can be used to create a computerized representation of pores that are included in particular geological formations.

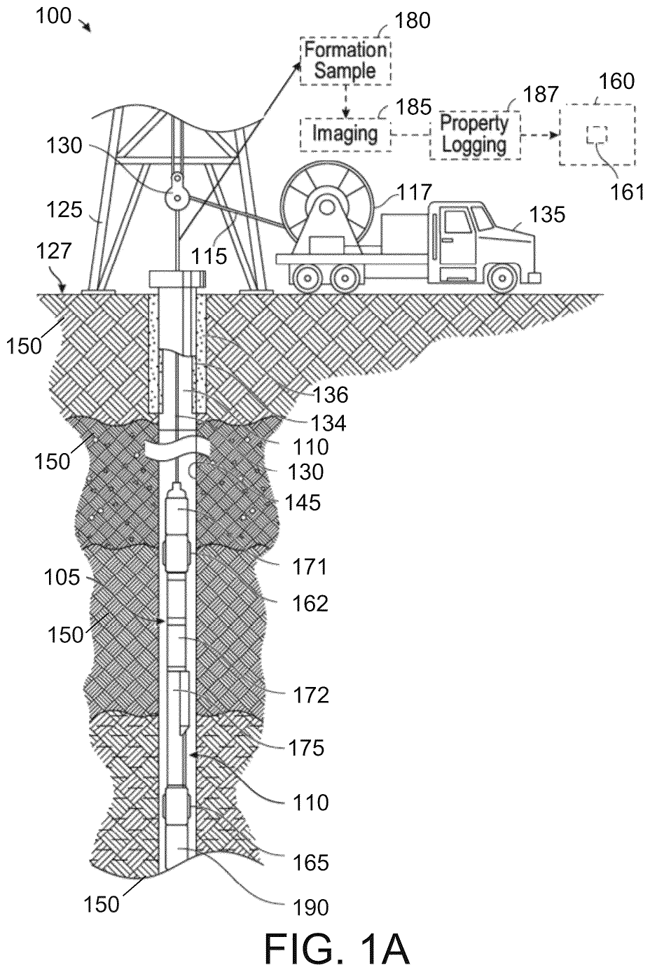

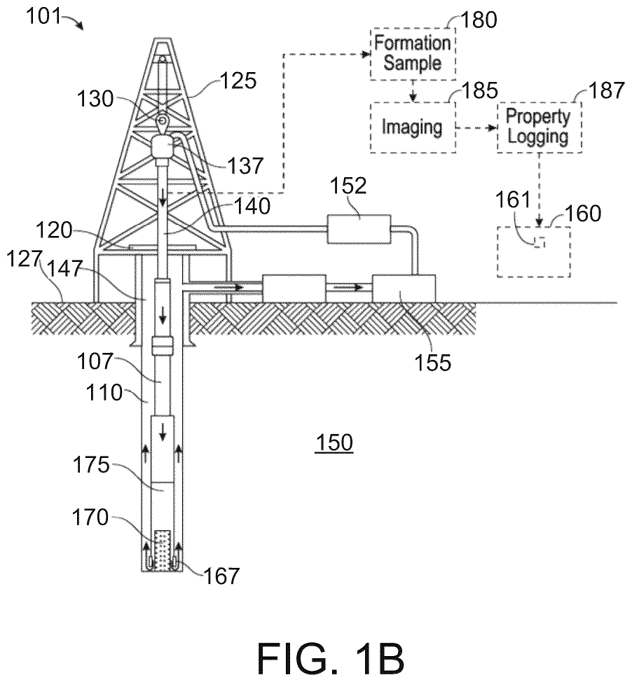

FIG. 1A is a schematic view of a wellbore operating environment in which a formation sample may be obtained. As depicted, operating environment 100 includes a derrick 125 that supports a hoist 130 at the surface 127 of the Earth. Here it may be assumed that a drill string has been removed from wellbore 110 to allow a downhole core sampling apparatus 105 to be lowered into wellbore 110 that has been previously drilled through one or more formations 150. As depicted, downhole core sampling apparatus 105 can be lowered into wellbore 110 by conveyance 115 coupled with hoist 130 drawn from spool 117. Casing 134 may have been previously secured within wellbore 110 by cement 136. The conveyance 115 can be anchored to derrick 125 or portable or mobile units such as truck 135. As depicted in FIG. 1A, the downhole core sampling apparatus 105 is lowered into wellbore 110 penetrating one or more formations 150 to a desired core sampling zone after which the downhole core sampling apparatus 105 may sample cores from the sidewall 145 of wellbore 110. The core sampling apparatus 105 can include an elongated housing suspended by conveyance 115 that includes an upper coupling 171, a first sealing element 162, a second sealing element 165, a sidewall coring tool 172, a core storage assembly 175, and a lower part 190 (e.g., a coupling, cap, or sensor). This core storage assembly 175 may be referred to as a core chamber used to store and move a formation core sample 180 to the surface 127.

While FIG. 1A depicts a first sealing element 162 and a second sealing element 165. A downhole core sampling apparatus 105 that includes only a single sealing element is within the spirit and scope of the present disclosure. Upon sealing engagement by first sealing element 162 and second sealing element 165, sidewall coring tool 172 may drill into or otherwise extract a formation sample from sidewall 145 of wellbore 110. The sidewall formation sample 180 may be brought to the surface 127 and subject to imaging 185, as well as formation property logging 187. The formation sample obtained may be any suitable length for testing or extraction, including about ½ inch (1.27 cm) to about 5 inches (12.7 cm), or alternatively from about 1 inch (2.54 cm) to about 4 inches (10.16 cm), or alternatively from about 1.5 inches (3.81 cm) to about 2.5 inch (6.35 cm) in length. These formation samples may be from about 1.5 to about 4 inches in diameter, or alternatively from about 2 inches to about 3 inches in diameter, or alternatively from about 2 to about 2.4 inches in diameter. The formation imaging 185 and/or property logging 187 may be carried out offsite in a laboratory. Processing center 160 may be employed for processing images, property logging and/or rendering graphics or carrying out other processing as disclosed herein and may include one or more processors 161 for such purpose. For instance, processing center 160 may be an on-site or off-site laboratory for analyzing image properties and log properties of the formation samples.

FIG. 1B illustrates an exemplary environment 101 in which a formation sample, also referred to as a core, may be extracted from a subterranean formation. The wellbore drilling environment 100 illustrates drill string 107 extending in wellbore 110 of formation 150. Drill string 107 extends from platform 120. FIG. 1B also includes platform 120 and derrick 125 that supports hoist 130. Hoist 130 may be used to raise or lower drill string 107 from the surface 127 of the Earth. Swivel 137 is provided from which an upper portion 140 of drill string 107 extends. A Kelly busing may allow drill string 107 to be rotated as it is lowered through well entrance 147. Pump 152 may be used to pump a drilling fluid in the direction shown by the arrows included in FIG. 1B. These arrows show the drilling fluid flowing down through drill string 107, then up through an annulus of wellbore 110, and horizontally to mud tank or pit 155. Processing center 160 may include one or more processors 161 that may be provided for control of a drilling operation and/or may be used to perform analysis on acquired image data. Sample analysis may be conducted in a laboratory on site or remotely and may be employed for processing imaging, property logging, rendering graphics, and/or for carrying out other processing as disclosed herein.

Drill string 107 may include hollowed drill bit 167. Drill bit 15 includes a hollow center or portion for receiving a formation core sample via coring tool portion 170. Drill string 107 may also include a core storage assembly 175 that receives and that retains the formation core sample from coring tool portion 170. Once the formation core sample 180 is transported to the surface images of the core sample may be acquired. Such a formation core sample 180 may be any suitable length for testing or extraction, including about ½ inch (1.27 cm) to about 5 inches (12.7 cm), or alternatively from about 1 inch (2.54 cm) to about 4 inches (10.16 cm), or alternatively from about 1.5 inches (3.81 cm) to about 2.5 inch (6.35 cm) in length. The formation samples may also be longer and may be less than 1 foot, or from 1 foot to 3 to 5 feet, or alternatively from 5 to 50 feet, or alternatively from 5 to 100 feet, or as much as 500 feet long. Longer samples may be cut into smaller samples of 1 to 4 feet for analysis. The formation sample may be extracted using coring tool portion 170 of FIG. 1B and this core sample may be in a cylindrical shape that fits within hollow drill bit 167 where it may be retained. The drill string 107 may incorporate components for logging while drilling (LWD) or measurement while drilling (MWD) which may measure various properties of the Earth formation. Data collected by LWD or MWD equipment may be communicated to the surface via one or more wires or wirelessly. Such wireless communications maty be sent using an acoustic transmission or using a mud pulse telemetry signal. In this way, in addition to obtaining a formation sample during drilling, imaging and or log properties can be obtained during drilling. Alternatively, or additionally, a drill string that includes core sampling apparatus 105 may be removed and wireline logging tools may be provided within the wellbore 110 to measure and log various properties of the formation 150, to obtain well bore images, and to extract formation samples from the walls of the well bore.

While FIGS. 1A and 1B illustrate ways of obtaining a formation sample (also referred to as cores in the field), the manner of obtaining a formation sample is not limited and may be obtained in any method. For instance, while drill bit 167 of FIG. 1B includes a hollow center, conventional drill bits may be employed, and formation cuttings and pieces of the formation obtained from conventional drilling may be used as samples.

Accordingly, formation samples may be obtained via sidewall core extraction tool 172 as shown in FIG. 1A, or via a hollow drill bit 167 as in FIG. 1B. The formation samples may be referred to as cores or core samples and may include but are not limited to whole cores (e.g., a cylindrically shaped cores), sidewall cores, slabbed cores, plugs, cuttings, formation fragments, and the like. The formation samples extracted from the wellbore or obtained in any other way can be iteratively subdivided into smaller samples (subsamples). The terms formation sample, formation core samples, or core samples encompasses the aforementioned whole cored sample, subsamples, portions of wellbore samples and fragments of samples. The term formation sample herein may also include formation components that are not extracted but which remain within the wellbore yet have been imaged or analyzed for its properties.

In order to evaluate the formation samples, imaging of the samples may be carried out. For instance, as shown in FIG. 1B, a formation sample 180, which may be the formation sample 180 or a portion thereof, may be subject to imaging 185 with an imaging device. The formation sample 180 may also be evaluated for formation properties via property logging 187 which may then be further processed in processing center 160 having one or more processors 161. As mentioned above, the imaging 185 and property logging 187 of a sample may be carried out offsite in a laboratory or elsewhere. Associated graphical rendering may be used to identify properties of an Earth formation even when laboratory analysis is not used.

Imaging performed by systems or techniques of the present disclosure may provide information regarding the physical structure, texture, and spatial distribution of properties of the formation sample or strata of the wellbore. Properties of samples taken from different locations of a wellbore may be analyzed such that images of structures of a formation may be generated and these images may identify properties of specific physical structures that are distributed throughout the formation. As such, an imaging device may be employed to inspect the formation sample and obtain desired images.

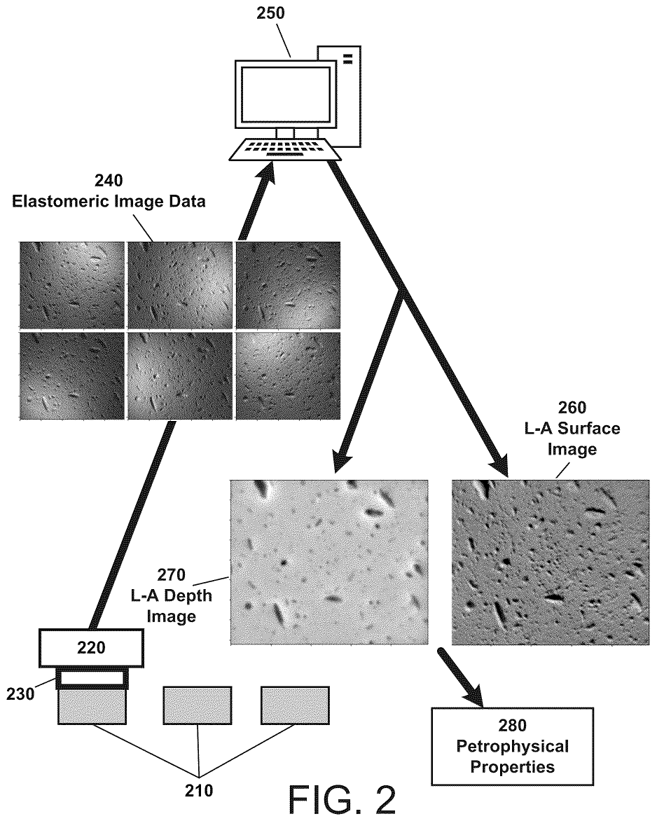

FIG. 2 illustrates a system that may collect images of a core sample, perform evaluations on those collected images, and make determinations regarding properties of the core sample based on the evaluations of the collected images. In some instances, as soon as core samples 210 are removed from a wellbore they may be scanned by elastomeric sensing device 220 and image set 240 acquired by elastomeric sensing device 220 may be provided to computer 250 such that one or more processors of computer 250 can execute instructions to enhance images of core samples 210. This may result in images 260 and 270 being generated and displayed on a display of computer 250.

Image data collected from a sample may include a set of images (e.g., six images) from the same perspective. Each respective image of this set of images may include areas within the image that are illuminated differently. In one instance, elastomeric sensing device may acquire respective images of a set of acquired images sequentially when respective light sources at the elastomeric sensing device are illuminated sequentially.

The process of acquiring data from a particular surface of a core sample may include contacting elastomeric surface 230 of elastomeric sensing device 220 to the core sample, illuminating a first light emitting diode (LED), and acquiring a first image of the surface of the core sample. This process may also include illuminating a second LED and acquiring a second image of the surface of the core sample. In instances when six images are included in a set of images of the surface of the core sample, each of the six images may be acquired when a different LED of the elastomeric sensing device 220. Capturing images using light sources located at different locations may help make changes in depth or height of a sample easier to identify. This is true even though these light effects may obscure features in an image set from which other determinations will be made.

Because of the illumination provided by the operation of elastomeric sensing device 220, each of the different images in image set 240 have areas that are illuminated from a different angle. Effects of these illuminations may result in glare, shadows, and changes in brightness that reduce an effective resolution of the elastomeric sensing device. As such, each respective image may include light effects (glare, shadows, and changes in brightness) that obfuscate details in each respective image. As such, light effects may obfuscate features of each of the images of image set 240. Images acquired by elastomeric sensing device 220 may have an orientation where a top, bottom, right, and left side of each of these images may be associated with orientations of North, South, East, and West. Light sources that affect angles of illumination of each image of image set 240 may be associated with a different reference orientation of the sample, for example, of North-East, East, South-East, North-West, West, and South-West.

In order to reduce or mitigate these light effects, once a set of images is acquired, the processors at computer 250 may perform techniques that allow images 260 and 270 to be generated. Note that image 260 does not have the light effects included in each of the images of image set 240. Instead, lighter and darker areas in image 270 correspond to areas where features (e.g., holes, cavities, or protrusions) of the sample are located. Image 270 may be an enhanced image generated based on removing or reducing light effects included in data of image set 240. Images that have light effects removed or reduced using techniques of the present disclosure may be referred to as light adjusted (L-A) images. As such, image 260 may be referred to as a light adjusted image of a surface of a sample (i.e., L-A surface image 260) and image 270 may be referred to as light adjusted (L-A) depth image 270.

Techniques used to remove lighting effects from acquired images may include applying Gaussian filters on sets of acquired data when resultant images are generated. In such instances, a plurality of different Gaussian filters may be applied on a set of acquired data to generate a plurality of different respective resultant images. Based on selection criteria, an image generated using one of these Gaussian filters may be selected and data of that selected image may be used when evaluations are performed to identify petrophysical parameters or other features of the sample. The processors of computer 250 may perform evaluations that allow specific petrophysical properties 280 of the sample to be identified, for example, based on features included in data of images 260 and 270.

While evaluations used to identify petrophysical properties 280 may be performed after light effects are removed from a set of images, in certain instances, evaluations may be performed to identify petrophysical properties directly from the set of acquired images.

A plurality of different evaluations may be performed to separate certain features (e.g., pores) of the sample from other features (e.g., flat surfaces of rock/rock matrix) of the sample. Such evaluations may be referred to as segmentation techniques. Some of these segmentation techniques may be consistent with an OTSU technique where different thresholds are applied to pixelated images. Such an OTSU technique or other segmentation technique may group individual pixels of an acquired image according to grayscale thresholds. Such techniques may use weighted variances between foreground and background pixels. Different thresholds may be used to identify a threshold that results in a minimum variance of a resulting pixelated image. Data of the resulting pixelated image may be evaluated to identify petrophysical properties of the sample (e.g., total porosity, pore size distribution, permeability, and/or pore aspect ratios).

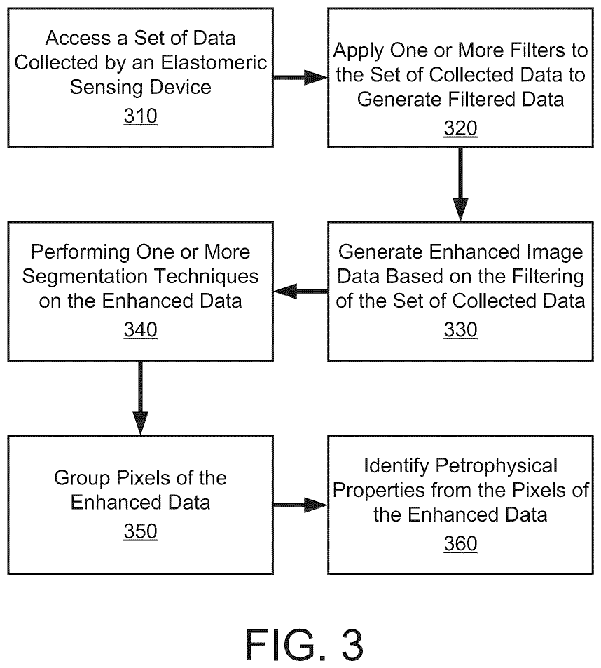

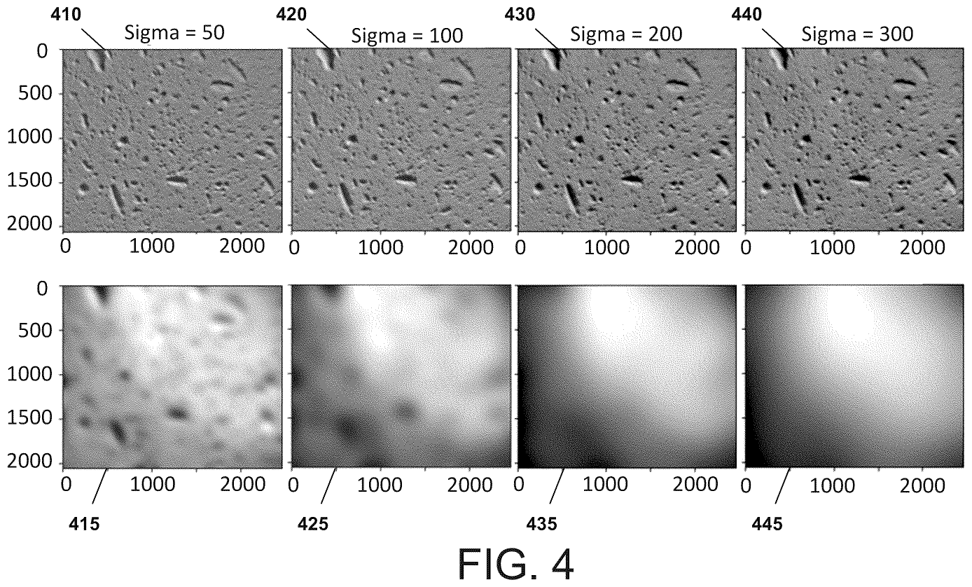

FIG. 3 illustrates actions that may be performed on images acquired by an elastomeric sensing device. At block 310 a set of data collected by an elastomeric sensing device may be accessed. This set of collected data may include the six images of image set 260 of FIG. 2. At block 320, one or more filters may be applied to the set of collected data. These filters may include a plurality of Gaussian filters, where each filter of the plurality of Gaussian filters uses a different value of sigma. Such Gaussian filters may be referred to as a Gaussian smoothing function that may blur an image as discussed in respect to the images of FIG. 4. Image data resulting from one of the Gaussian filters being applied to the accessed set of image data may be selected based on a criterion or rule. Such a criterion or rule may require that light variance of a resulting light-adjusted (L-A) image should correspond to a range of light intensity. The criterion may require that a certain percentage of features or areas of a resultant image be blurred or undiscernible as distinct features. An enhanced image data or a L-A resulting image may be generated at block 330 using the filter selected based on the criterion or rule. A set of depth data may also be generated at block 330. In certain instances, data representing the L-A resulting image and L-A depth image may be used to generate the L-A resulting image and the L-A depth image from raw image data includes the distorting light effects disused herein.

At block 340, one or more segmentation techniques may be applied to the enhanced image data generated at block 330. This may include combining the data of the resulting image with depth information to generate image data or images that accentuates contrasts between areas of the sample surface that includes pores from areas of the sample surface that includes rock matrix (e.g., pore free rock surfaces). This process may also include rescaling of the images to guarantee that features included in each of the images are aligned. Various techniques may be used to combine the resulting image with the depth image. Such techniques include yet are not limited to a linear combination or a minimization technique.

A combined image may include lighter colors or shades of gray that identify areas of the sample's surface where pores are located and may include darker colors that identify areas of the sample's surface that are comprised of rock matrix.

At block 340, pixels of the combined image may be grouped. Pixels associated with pore space may be grouped into groups using various different segmentation techniques. In certain instances, areas where pores are located may be assigned a white color and areas where rock matrix (e.g., areas are pore free or that include smooth rock surfaces) may be assigned a black color. As such, the black and white areas where rock matrix versus pores may be depicted in a “binary” image that separates the portions of rock matrix from pore spaces.

FIG. 4 illustrates the results of applying Gaussian filtering functions with different values of sigma on a set of image data. An example of a Gaussian filtering function is shown in formula 1 below. In formula 1, sigma is represented by the symbol σ.

$$G ( x , y ) = \frac{1}{2 {πσ}^{2}} {e}^{- \frac{{x}^{2} + {y}^{2}}{2 {σ}^{2}}} \qquad Formula 1$$

$$Gaussian Filtering Function$$

The upper images (410, 420, 430, & 440) of FIG. 4 show features (e.g., pores and rock matrix) of the sample's surface more clearly than the lower images (415, 425, 435, & 445) of FIG. 4. The lower four images (415, 425, 435, & 445) of FIG. 4 show blurring effects of respective Gaussian functions. Images 410, 420, 430, and 440 may be filtered images that were generated after applying Gaussian filters or original images 415, 425, 435, and 445. Images 415, 425, 435, & 445 may be referred to as blurred images that include different levels of blurring or blurred light effects.

The process of removing these light effects may be consistent with actions of blocks 310 and 320 of FIG. 3 where data collected by an elastomeric sensing device is accessed and where one or more filters are applied to the collected data. By applying a Gaussian filter to the collected data using respective values of sigma of 50, 100, 200, & 300 may result in image data of images 415, 425, 435, & 445 being generated. Image data of images 410, 420, 430, & 440 may have been generated by removing light effects of images 415, 425, 435, & 445 respectively. Here data of image 415 may be used to generate data of image 410, data of image 425 may be used to generate data of image 420, data of image 435 may be used to generate data of image 430, and data of image 445 may be used to generate data of image 440. The Gaussian filtering functions discussed above may be used to filter data from an original set of images acquired by an elastomeric filtering device (e.g., image set 240 of FIG. 2). This may include using a Gaussian filtering function with values of sigma of 50, 100, 200, and 300.

A criterion or rule for identifying which value of sigma should be used to generate a resulting image may dictate a range of blurring effect that removes at least a first threshold level of image detail without removing more than a second threshold level of image detail. Note that as sigma rises, blurring effects remove more details from the resulting blurred images. Metrics used to identify a level of blurring effect may include percentage of details obfuscated in a blurred image, percentage of details that remain in a blurred image, or a variance in lighter areas versus darker areas of a blurred image.

Note that image 415 includes numerous dark spots, image 425 includes some dark spots, image 435 includes gradual transitions between dark and light areas of the image, and image 445 includes nearly no dark areas. Based on the selection criteria or rule, images 415 and 425 may be disregarded because those images do not include a threshold level of blurring or object obfuscation, image 445 may be disregarded as including too much blurring or too much object obfuscation, and image 435 may be used to identify that a sigma value of 200 is the correct sigma value to identify light effects that should be removed when a resulting increased resolution image 430 is generated.

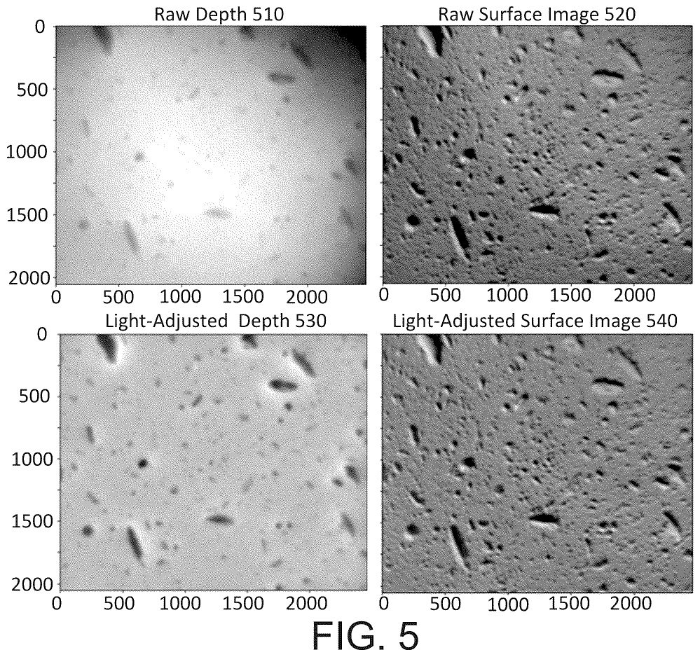

FIG. 5 illustrates a set of raw images and a set of light-adjusted images generated according to methods of the present disclosure. FIG. 5 includes raw depth image 510, raw surface image 520, light-adjusted depth image 530, and light adjusted surface image 540. By performing actions consistent with the present disclosure, light effects that tend to obfuscate details in images 510 and 520 may be used to generate the clearer or higher resolution light-adjusted images 530 and 540 of FIG. 5 and the light adjusted images 260 and 270 of FIG. 2. Note that the light adjusted images 530 and 540 may have been generated by one or more processors of a computer system when those processors generate the enhanced images generated at block 330 of FIG. 3.

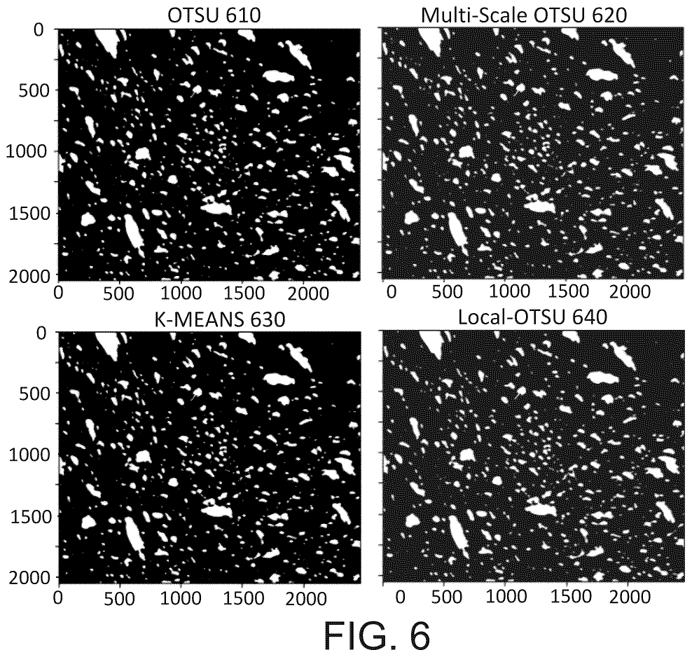

FIG. 6 illustrates the results of four different segmentation techniques applied to a set of image data. Here the four different segmentation techniques applied to the set of image data include an OTSU thresholding technique, a Multi-Scale OTSU thresholding technique, a K-Means clustering technique, and the Local-OTSU thresholding technique. Image 610 was generated based on results of the OTSU thresholding technique, image 620 was generated based on results of the Multi-Scale OTSU thresholding technique, image 630 was generated based on results of the K-Means clustering technique, and image 640 was generated based on results of the Local-OTSU thresholding technique. These four different segmentation techniques may be applied at block 340 of FIG. 3. Here again, one or more processors of the computer that generates enhanced images may be used to perform these segmentation techniques.

The white colored regions of images 610, 620, 630, and 640 depict pores located on a surface of a sample and the black colored regions of images 610, 620, 630, and 640 depict areas of the sample's surface that are comprise of rock matrix. An analysis of a selected set of image data may include identifying and grouping pixels that have a white color, each of these groupings may be associated with a region or specific locations within the image represented by the selected set of image data. This grouping function may be the same as the grouping of pixels action discuss in respect to block 350 of FIG. 3. Images 610, 620, 630, and 640 may be referred to as binary images that show pore spaces in white and where portions of rock matrix are shown in black in respective black and white images.

A visual comparison of the light-adjusted depth image 530 and the light-adjusted surface image 540 of FIG. 5 with the different images 610, 620, 630, and 640 of FIG. 6 may be performed. In such a comparison, locations, sizes, and/or areas- and possibly apparent depths of features included in light-adjusted images 530 and 540 may be compared with locations, sizes, and/or areas of features included in images 610, 620, 630, and 640 of FIG. 6. When such a comparison indicates that the locations sizes, and/or areas of the light-adjusted images 530 and 540 correspond to an image generated by a segmentation technique to a threshold level, the results of that segmentation technique may be classified as being representative of features of the surface of a sample from which images 530 and 540 were generated.

While each one of the white colored regions and black colored regions of the images 610, 620, 630, and 640 of FIG. 6 appear to correspond to locations, sizes, and/or areas of the features of the light-adjusted images 530 and 540, an analysis performed by a computer may identify that all of the segmentation technique images 610, 620, 630, and 640 correspond to a threshold degree to features of the light-adjusted images 530 and 540. Such analysis may be used to identify a segmentation technique that most accurately identifies pores of a sample. Once a segmentation technique that accurately identifies pores of the sample is identified, an analysis may be performed. In such an instance, data identifying white colored areas of an image generated using the identified segmentation technique may be used to identify pore spaces and various petrophysical parameters that may be related to the pore space. Note that this identification of pore spaces and petrophysical parameters may be performed at block 360 of FIG. 3.

In certain instances, each of the different images of 610, 620, 630, and 640 of FIG. 6 may be compared to each other to validate that these different images compare to each other to the threshold degree. This may include comparing locations, sizes, and/or areas of one or more of the white colored regions and/or black colored regions in one of these images to another of these images. As such, in instances when respective areas of one image corresponds to a threshold degree to respective areas of another image, those two images may be judged to be equivalent.

While any one of these segmentation techniques may provide equivalent results as compared to another one of these segmentation techniques, this may not always be the case. As such, one segmentation technique may generate image data that includes features that more closely corresponds to features of a set of light-adjusted data than any of the other segmentation techniques. In such an instance, only one segmentation technique may be used to generate data used to identify pore space and/or petrophysical parameters of the sample.

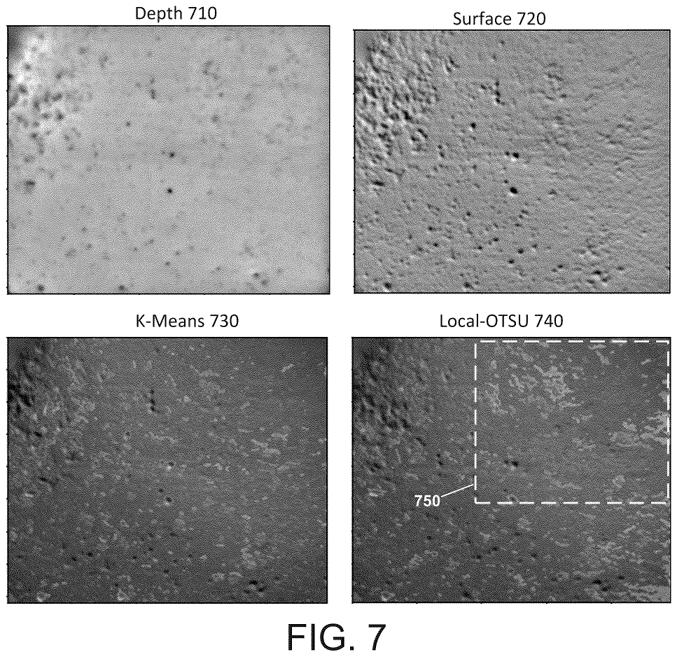

FIG. 7 illustrates how an image generated using one segmentation technique may more accurately represent pores of a sample than an image generated using another segmentation technique. FIG. 7 includes four different images of the surface of a sample. These four images are depth image 710, sample surface image 710, K-Means image 730, and Local-OTSU image 740. Techniques of the present disclosure may use a processor executing instructions out of a memory to compare depth image data of image 710 and sample surface image data of image 720 with K-Means image data used to generate image 730 of FIG. 7. Such a comparison may identify whether the K-Means image data conforms to a threshold level to the image depth data and the surface image data. Alternatively, or additionally, such a comparison may generate a compliance score. The more depths of the image data or features of the surface image data correspond, the higher compliance score may be assigned to the K-Means image data. Similarly, the depth image data of image 710 and the sample surface image data of image 720 may be compared with OTSU-Local image data used to generate image 740 of FIG. 7.

Data from each different segmentation technique used to make evaluations of the present disclosure may be compared to depth image data and surface image data such that one or more sets of resulting data may be selected to identify petrophysical parameters of the sample. In certain instances, a compliance score threshold may be used to select sets of data from which petrophysical parameters will be determined. Any dataset that has a compliance score that at least meets the compliance score threshold may be selected for identifying petrophysical parameters of the sample.

Comparisons of depth image 710, surface image 720 respectively with K-Means image 730 and with Local-OTSU image 740 may be used to eliminate data used to generate the Local-OTSU image 740 from further evaluation. This may be because, the Local-OTSU image 740 includes features withing box 750 that do not correspond to depths image 710 and/or surface image 720. Here data used to generate the K-Means image 730 may be used to identify petrophysical parameters of the sample because the K-Means data corresponds, to a threshold degree, to the image data used to draw depth image 710 and/or the surface data used to draw surface image 720. A segmentation rule may identify a specific a level of correspondence between data generated using a segmentation technique and depth and/or surface data of one or more images like depth image 710 data and surface image 720 data. For example, a segmentation rule may dictate that data generated by a segmentation rule should match depths and/or sizes of specific pores located in sets of depth data or surface image data by a factor of 70% to meet the threshold segmentation rule.

Petrophysical properties that may be identified using data associated with a selected segmentation technique include total porosity and pore size distribution. The total porosity of a sample may be identified by an analysis performed on data. For example, a total porosity may be identified by the total number of pixels that have the white color divided by the total size of the image. A given image may include different pores of different sizes. Each discrete pore of a sample may be represented in an image using adjacent pixels that have a white color. A grouping of such adjacent pixels may be used to identify a pore space represented by those adjacent pixels. The porosity of that pore space may correspond to the sum of the pixels of that pore space. A radius of that pore space may be identified by assuming that the pore space is circular in shape. A particular image may include many different pore spaces that may have different sizes. A pore space distribution may be identified by identifying the area of the image, calculating a total area of the pores included in that image area, and by dividing the total area of the pores in the image area by the area of the image.

The techniques of the present disclosure may be validated by comparing results of these techniques with other methods used to determine petrophysical properties. These other methods may include yet are not limited to the use of a nuclear magnetic resonance (NMR) sensing device. NMR sensing devices operate by stimulating a sample with magnetic fields and by measuring how spins of materials included in that sample change over time. One measure made using an NMR sensing device is an NMR T2 relaxation time or a T2 relaxation time distribution. Such NMR T2 relaxation times may correspond to measures of surface relaxivity. The surface relaxivity may be used as a factor to transform respective NMR T2 time distributions to respective pore sizes. Surface relaxivity may be calculated as the ratio of the geometric mean of the pore size distribution and the geometric mean of an NMR T2 time distribution.

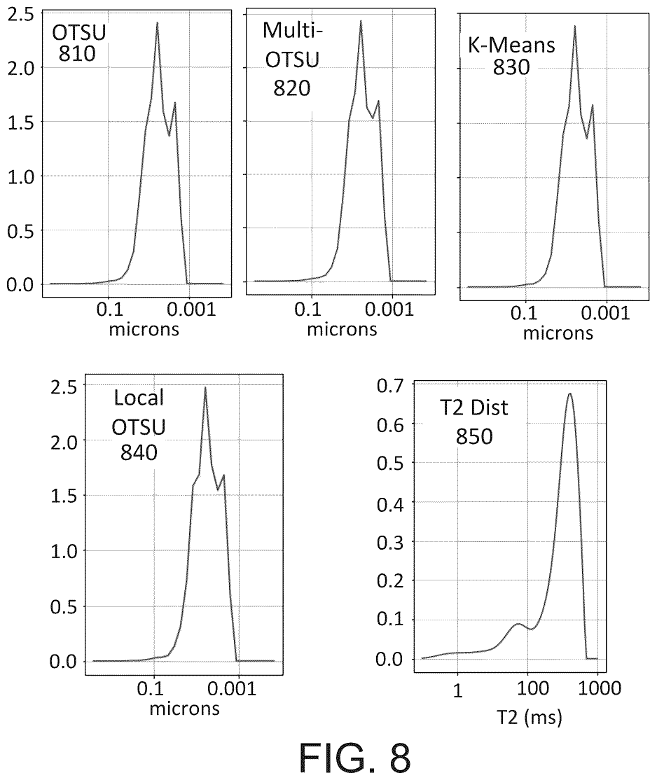

FIG. 8 illustrates graphs of four sets of data generated (e.g., pore size distributions) by application of a different segmentation technique on a set of image data of a sample, FIG. 8 also includes a graph of NMR T2 distribution time data of the sample. Graphs 810, 820, 830, and 840 of FIG. 8 each include a horizontal axis of pore radius and a vertical axis of pore volume. Graph 810 was generated from data generated using the OSTU segmentation technique, graph 820 was generated using the Multi-OTSU segmentation technique, graph 830 was generated using the K-Means segmentation technique, and graph 840 was generated using the Local-OTSU segmentation technique.

Graph 850 of FIG. 8 shows an NMR T2 time distribution curve. Graph 850 has a horizontal axis of T2 time in milliseconds (ms) and a vertical axis of NMR signal intensity. The T2 distribution curve of graph 850 may have been generated based on data collected by an NMR sensing device that scanned the sample.

Evaluations may be performed on data generated by each segmentation technique to identify values associated with respective graphs 810, 820, 830, and 840. For example, geometric mean values or maximum values of the OTSU, Multi-OTSU, K-Means, and Local-OTSU distribution curves may be identified. Equations may be used to transform NMR T2 distribution data into pore size based on a surface relaxivity ρ. Table 1 shows geometric mean data and maximum values identified by the evaluations on the data generated by each segmentation technique. Table 1 also shows values derived from the application of the surface relaxivity equations.

The surface relaxivity ρ may be dependent on the mineralogy and the surface chemistry, the “ρintrinsic” value of the sample. The surface relaxivity ρ may be affected by a geometric factor of the sample and/or a surface roughness of the sample. Assuming that the pore structures of the sample can be modeled as smooth spherical bodies of radius r, where r=3ρT₂. As such, pore radius may correspond to the product of the number three, surface relaxivity ρ, and T2 time. Furthermore, values of surface relaxivity ρ may correspond to ρintrinsic values based on the equation: ρ=ρ_{intrinsic} (1+2R) where R is the surface roughness. For the sample of FIG. 7, the surface roughness R=3.21. Hence, the computed intrinsic surface relaxivities are listed in the third row of Table 1.

TABLE 1
Surface Relaxivity

| | | | | Multi- | K- | Local- |
|---|---|---|---|---|---|---|
| 1 | | Method | OTSU | OTSU | MEANS | OTSU |
| 2 | ρ (μm/s) | Geometric | 285.74 | 286.22 | 286.54 | 286.22 |
| | | Mean | | | | |
| 3 | ρ_{intrinsic} | Geometric | 12.83 | 12.85 | 12.87 | 12.85 |
| | (μm/s) | Mean | | | | |
| 4 | ρ (μm/s) | Max | 96.08 | 96.25 | 96.08 | 95.57 |
| 5 | ρ_{intrinsic} | Max | 12.84 | 12.86 | 12.87 | 12.86 |
| | (μm/s) | | | | | |

In certain instances, surface relaxivity values derived from images sensed by an elastomeric sensing device may not correspond to relaxivity values determined from other analysis. This may be related to the resolution of the elastomeric sensing device. Because of this, instead of using geometric mean of pore size and T2 distributions for computing the surface relaxivity, the ratio of a maximum peak pore size and NMR T2 distributions may be used to make further evaluations that may include identifying aspect ratios of pore's of the sample.

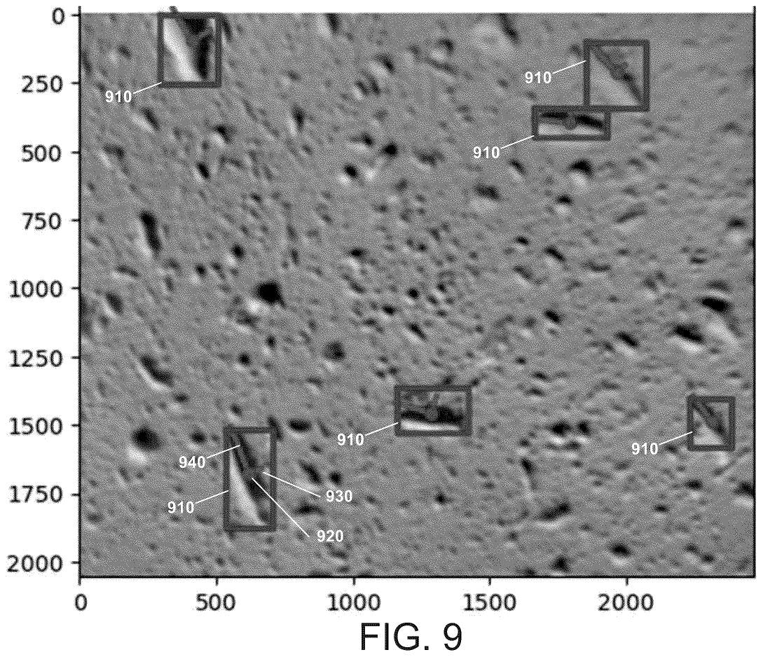

FIG. 9 illustrates bounding boxes drawn around specific pore spaces that may be used to identify aspect ratios of those pore spaces. Once locations of specific bounding boxes 910 are identified, aspect ratios for each respective pore space may be identified. For example, an aspect ratio for pore space 920 may be determined by identifying minimum axis length 930 and maximum axis length 940 of pore space 920. The aspect ratio of pore space 920 may be computed as the ratio of the minimum axis length 930 and the maximum axis length 940 of pore space 920. Lines identifying minimum axis length 930 and maximum axis length 940 of pore space 920 may have the same normalized central moments of pore space 920.

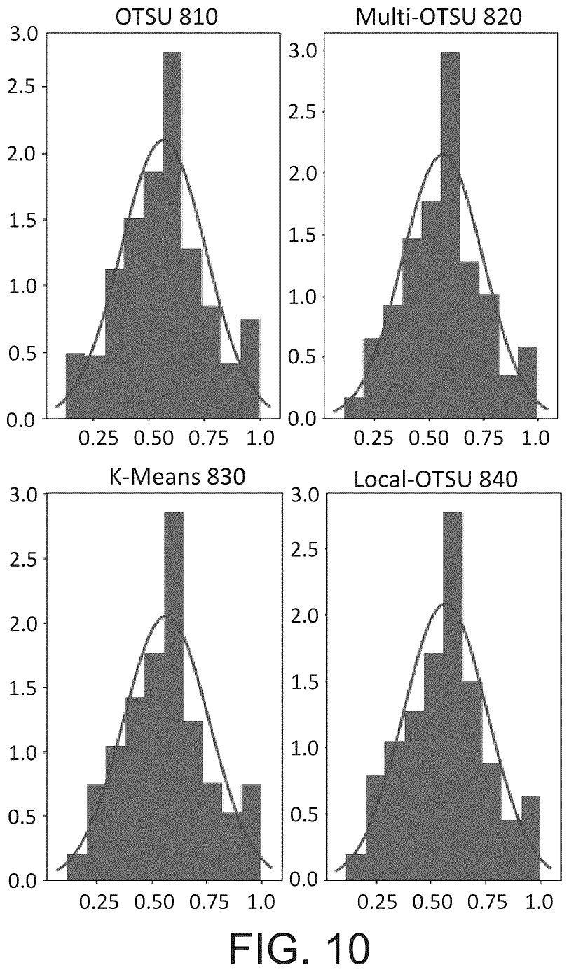

FIG. 10 includes graphs of histograms of pore space aspect ratios derived using different image segmentation techniques. FIG. 10 includes four different histogram graphs, respectively graphs 810, 820, 830, and 840 were generated from data respectively from the OTSU, the Multi-OTSU, the K-Means, and the Local-OTSU segmentation techniques. Each of graphs 810, 820, 830, and 840 have a horizontal axis of—minimum axis length—and a vertical axis of—maximum axis length—for pores (the white areas) of the sample associated with FIG. 6.

Pore aspect ratios identified using techniques of the present disclosure may be used to identify petrophysical properties (e.g., porosity or permeability values) of the sample. Areas of a wellbore where that sample originated may be assumed to have similar petrophysical properties of the sample.

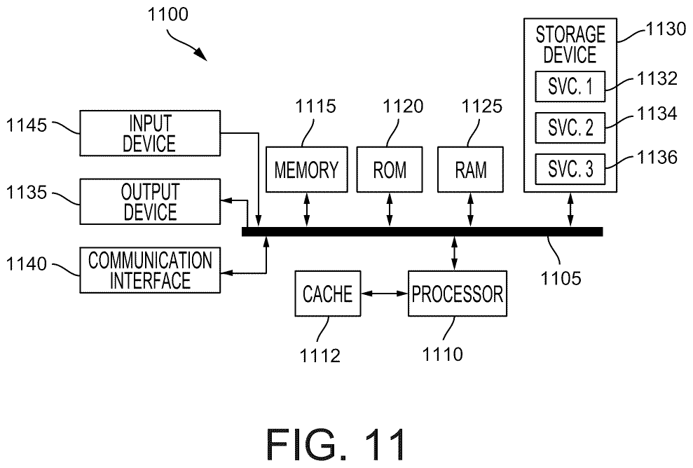

FIG. 11 illustrates an example computing device architecture 1100 of a computing device which can implement the various technologies and techniques described herein. The various implementations will be apparent to those of ordinary skill in the art when practicing the present technology. Persons of ordinary skill in the art will also readily appreciate that other system implementations or examples are possible. The components of the computing device architecture 1100 are shown in electrical communication with each other using a connection 1105, such as a bus. The example computing device architecture 1100 includes a processing unit (CPU or processor) 1110 and a computing device connection 1105 that couples various computing device components including the computing device memory 1115, such as read only memory (ROM 1120) and random-access memory (RAM 1125), to the processor 1110.

The computing device architecture 1100 can include a cache of high-speed memory connected directly with, in close proximity to, or integrated as part of the processor 1110. The computing device architecture 1100 can copy data from the memory 1115 and/or the storage device 1130 to the cache 1112 for quick access by the processor 1110. In this way, the cache can provide a performance boost that avoids processor 1110 delays while waiting for data. These and other modules can control or be configured to control the processor 1110 to perform various actions. Other computing device memory 1115 may be available for use as well. The memory 1115 can include multiple different types of memory with different performance characteristics. The processor 1110 can include any general-purpose processor/multi-processor and a hardware or software service, such as service 1 1132, service 2 1134, and service 3 1136 stored in storage device 1130, configured to control the processor 1110 as well as a special-purpose processor where software instructions are incorporated into the processor design. The processor 1110 may be a self-contained system, containing multiple cores or processors, a bus, memory controller, cache, etc. A multi-core processor may be symmetric or asymmetric.

To enable user interaction with the computing device architecture 1100, an input device 1145 can represent any number of input mechanisms, such as a microphone for speech, a touch-sensitive screen for gesture input, keyboard, mouse, motion input, speech and so forth. An output device 1135 can also be one or more of a number of output mechanisms known to those of skill in the art, such as a display, projector, television, speaker device, etc. In some instances, multimodal computing devices can enable a user to provide multiple types of input to communicate with the computing device architecture 1100. The communications interface 1140 can generally govern and manage the user input and computing device output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof. The storage device 1130 can include services 1132, 1134, 1136 for controlling the processor 1110. Other hardware or software modules are contemplated. The storage device 1130 can be connected to the computing device connection 1105. In one aspect, a hardware module that performs a particular function can include the software component stored in a computer-readable medium in connection with the necessary hardware components, such as the processor 1110, connection 1105, output device 1135, and so forth, to carry out the function.

For clarity of explanation, in some instances the present technology may be presented as including individual functional blocks including functional blocks comprising devices, device components, steps or routines in a method embodied in software, or combinations of hardware and software.

In some instances the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Aspects of the disclosure include:

Aspect 1: A method comprising: accessing image data of a surface of a sample that includes pore spaces and portions of rock matrix, wherein the image data is associated with data acquired by an elastomeric sensing device; applying one or more segmentation techniques on the image data based on the image data being associated with the data acquired by the elastomeric sensing device; transforming the image data into a binary image that separates the pore spaces from the portions of the rock matrix based on at least one segmentation technique of the one or more segmentation techniques; and identifying one or more petrophysical properties of the sample based on the binary image that separates the pore spaces from the portions of the rock matrix.

Aspect 2: The method of Aspect 1, further comprising: receiving data sensed by the elastomeric sensing device, wherein the sensed data includes a plurality of images of the surface of the sample and each image of the plurality of images includes light effects associated with illumination provided by the elastomeric sensing device; applying a filter function on the data sensed by the elastomeric sensing device to reduce the light effects associated with the illumination provided by the elastomeric sensing device; and generating a combined image based on the application of the filter function that reduces the light effects associated with the illumination provided by the elastomeric sensing device.

Aspect 3: The method of Aspect 2, wherein the illumination of each respective image of the plurality of images is provided at a different angle relative to a reference orientation of the sample.

Aspect 4: The method of any of Aspects 1 through 3, further comprising: applying the filter function one or more additional times on the data sensed by the elastomeric sensing device, wherein: the filter function is performed with a different value of a variable each time the filter function is applied, and the application of the filter function results in a respective level blurring effect of the combined image for each value of the different values of the variable. This method may also include identifying a value of the different values of the variable that results in an amount of blurring effect that corresponds to a filtration rule, wherein the combined image is generated using the different values of the variable that results in the amount of the blurring effect that corresponds to the filtration rule.

Aspect 5: The method of Aspect 4, wherein the filtration rule identifies a range of light artifact uniformity of a resulting image, wherein the range of light artifact uniformity is associated with the resulting image corresponds to a threshold percentage of the pore spaces of the surface of the sample.

The method of any of Aspects 1 through 5, further comprising: receiving data sensed by the elastomeric sensing device, wherein the sensed data includes a plurality of images of the surface of the sample; and generating one or more combined images from the data sensed by the elastomeric sensing device.

The method of Aspect 6, wherein the one or more combined images includes a depth image and an image of the surface of the sample.

The method of any of Aspects 1 through 6, further comprising: comparing image data associated with the one or more segmentation techniques to data indicative of at least one of depth or location of the pore spaces of the surface of the sample; and identifying that image data associated with a first segmentation technique of the one or more segmentation techniques corresponds to a threshold of a segmentation rule, wherein the image data is transformed into the binary image based on the image data being associated with the identification that the first segmentation technique of the one or more segmentation techniques corresponds to the threshold of the segmentation rule.

Aspect 9: A non-transitory computer-related storage medium having embodied thereon instructions that when executed by one or more processors cause the one or more processors to: access image data of a surface of a sample that includes pore spaces and portions of rock matrix, wherein the image data is associated with data acquired by an elastomeric sensing device; apply one or more segmentation techniques on the image data based on the image data being associated with the data acquired by the elastomeric sensing device; transform the image data into a binary image that separates the pore spaces from the portions of the rock matrix based on at least one segmentation technique of the one or more of segmentation techniques; and identify one or more petrophysical properties of the sample based on the binary image that separates the pore spaces from the portions of the rock matrix.

Aspect 10: The non-transitory computer-related storage medium of Aspect 9, wherein the one or more processors execute the instructions to: receive data sensed by the elastomeric sensing device, wherein the sensed data includes a plurality of images of the surface of the sample and each image of the plurality of images includes light effects associated with illumination provided by the elastomeric sensing device; apply a filter function on the data sensed by the elastomeric sensing device to reduce the light effects associated with the illumination provided by the elastomeric sensing device; and generate a combined image based on the application of the filter function that reduces the light effects associated with the illumination provided by the elastomeric sensing device.

Aspect 11: The non-transitory computer-related storage medium of Aspect 10, wherein the illumination of each respective image of the plurality of images is provided at a different angle relative to a reference orientation of the sample.

Aspect 12: The non-transitory computer-related storage medium of Aspect 10, wherein the one or more processors execute the instructions to: apply the filter function one or more additional times on the data sensed by the elastomeric sensing device, wherein: the filter function is performed with a different value of a variable each time the filter function is applied, and the application of the filter function results in a respective level blurring effect of the combined image for each value of the different values of the variable. the one or more processors execute the instructions to identify a value of the different values of the variable that results in an amount of blurring effect that corresponds to a filtration rule, wherein the combined image is generated using the different values of the variable that results in the amount of the blurring effect that corresponds to the filtration rule.

Aspect 13: The non-transitory computer-related storage medium of Aspect 12, wherein the filtration rule identifies a range of light artifact uniformity of a resulting image, wherein the range of light artifact uniformity is associated with the resulting image corresponds to a threshold percentage of the pore spaces of the surface of the sample.

Aspect 14: The non-transitory computer-related storage medium of any of Aspects 9 through 13, wherein the one or more processors execute the instructions to: receive data sensed by the elastomeric sensing device, wherein the sensed data includes a plurality of images of the surface of the sample; and generate one or more combined images from the data sensed by the elastomeric sensing device.

Aspect 15: The non-transitory computer-related storage medium of Aspect 14, wherein the one or more combined images includes a depth image and an image of the surface of the sample.

Aspect 16: The non-transitory computer-related storage medium of any of Aspects 9 through 15, wherein the one or more processors execute the instructions to: compare image data associated with the one or more segmentation techniques to data indicative of at least one of depth or location of the pore spaces of the surface of the sample; and identify that image data associated with a first segmentation technique of the one or more segmentation techniques corresponds to a threshold of a segmentation rule, wherein the image data is transformed into the binary image based on the image data being associated with the identification that the first segmentation technique of the one or more segmentation techniques corresponds to the threshold of the segmentation rule.

Aspect 17: A system comprising: an elastomeric sensing apparatus; a memory; and one or more processors that execute instructions out of the memory to: access image data of a surface of a sample that includes pore spaces and portions of rock matrix, wherein the image data is associated with data acquired by an elastomeric sensing device, apply one or more segmentation techniques on the image data based on the image data being associated with the data acquired by the elastomeric sensing device, transform the image data into a binary image that separates the pore spaces from the portions of the rock matrix based on at least one segmentation technique of the one or more segmentation techniques, and identify one or more petrophysical properties of the sample based on the binary image that separates the pore spaces from the portions of the rock matrix.

Aspect 18: The system of Aspect 17, wherein the one or more processors execute the instructions to: receive data sensed by the elastomeric sensing device, wherein the sensed data includes a plurality of images of the surface of the sample and each image of the plurality of images includes light effects associated with illumination provided by the elastomeric sensing device; apply a filter function on the data sensed by the elastomeric sensing device to reduce the light effects associated with the illumination provided by the elastomeric sensing device; and generate a combined image based on the application of the filter function that reduces the light effects associated with the illumination provided by the elastomeric sensing device.

Aspect 19: The system of Aspect 18, wherein the illumination of each respective image of the plurality of images is provided at a different angle relative to a reference orientation of the sample.

Aspect 20: The system of Aspect 18, wherein the one or more processors execute the instructions to: apply the filter function one or more additional times on the data sensed by the elastomeric sensing device, wherein: the filter function is performed with a different value of a variable each time the filter function is applied, and the application of the filter function results in a respective level blurring effect of the combined image for each value of the different values of the variable; and identify a value of the different values of the variable that results in an amount of blurring effect that corresponds to a filtration rule, wherein the combined image is generated using the different values of the variable that results in the amount of the blurring effect that corresponds to the filtration rule.

What is claimed is:

1. A method comprising:
accessing image data of a surface of a sample that includes pore spaces and portions of rock matrix, wherein the image data is associated with data acquired by an elastomeric sensing device;
applying one or more segmentation techniques on the image data based on the image data being associated with the data acquired by the elastomeric sensing device;
transforming the image data into a binary image that separates the pore spaces from the portions of the rock matrix based on at least one segmentation technique of the one or more segmentation techniques; and
identifying one or more petrophysical properties of the sample based on the binary image that separates the pore spaces from the portions of the rock matrix.

2. The method of claim 1, further comprising:
receiving data sensed by the elastomeric sensing device, wherein the sensed data includes a plurality of images of the surface of the sample and each image of the plurality of images includes light effects associated with illumination provided by the elastomeric sensing device;
applying a filter function on the data sensed by the elastomeric sensing device to reduce the light effects associated with the illumination provided by the elastomeric sensing device; and
generating a combined image based on the application of the filter function that reduces the light effects associated with the illumination provided by the elastomeric sensing device.

3. The method of claim 2, wherein the illumination of each respective image of the plurality of images is provided at a different angle relative to a reference orientation of the sample.

4. The method of claim 2, further comprising:
applying the filter function one or more additional times on the data sensed by the elastomeric sensing device, wherein:
the filter function is performed with a different value of a variable each time the filter function is applied, and
the application of the filter function results in a respective level blurring effect of the combined image for each value of the different values of the variable; and
identifying a value of the different values of the variable that results in an amount of blurring effect that corresponds to a filtration rule, wherein the combined image is generated using the different values of the variable that results in the amount of the blurring effect that corresponds to the filtration rule.

5. The method of claim 4, wherein the filtration rule identifies a range of light artifact uniformity of a resulting image, wherein the range of light artifact uniformity is associated with the resulting image corresponds to a threshold percentage of the pore spaces of the surface of the sample.

6. The method of claim 1, further comprising:
receiving data sensed by the elastomeric sensing device, wherein the sensed data includes a plurality of images of the surface of the sample; and
generating one or more combined images from the data sensed by the elastomeric sensing device.

7. The method of claim 6, wherein the one or more combined images includes a depth image and an image of the surface of the sample.

8. The method of claim 1, further comprising:
comparing image data associated with the one or more segmentation techniques to data indicative of at least one of depth or location of the pore spaces of the surface of the sample; and
identifying that image data associated with a first segmentation technique of the one or more segmentation techniques corresponds to a threshold of a segmentation rule, wherein the image data is transformed into the binary image based on the image data being associated with the identification that the first segmentation technique of the one or more segmentation techniques corresponds to the threshold of the segmentation rule.

9. A non-transitory computer-related storage medium having embodied thereon instructions that when executed by one or more processors cause the one or more processors to:
access image data of a surface of a sample that includes pore spaces and portions of rock matrix, wherein the image data is associated with data acquired by an elastomeric sensing device;
apply one or more segmentation techniques on the image data based on the image data being associated with the data acquired by the elastomeric sensing device;
transform the image data into a binary image that separates the pore spaces from the portions of the rock matrix based on at least one segmentation technique of the one or more of segmentation techniques; and
identify one or more petrophysical properties of the sample based on the binary image that separates the pore spaces from the portions of the rock matrix.

10. The non-transitory computer-related storage medium of claim 9, wherein the one or more processors execute the instructions to:
receive data sensed by the elastomeric sensing device, wherein the sensed data includes a plurality of images of the surface of the sample and each image of the plurality of images includes light effects associated with illumination provided by the elastomeric sensing device;
apply a filter function on the data sensed by the elastomeric sensing device to reduce the light effects associated with the illumination provided by the elastomeric sensing device; and
generate a combined image based on the application of the filter function that reduces the light effects associated with the illumination provided by the elastomeric sensing device.

11. The non-transitory computer-related storage medium of claim 10, wherein the illumination of each respective image of the plurality of images is provided at a different angle relative to a reference orientation of the sample.

12. The non-transitory computer-related storage medium of claim 10, wherein the one or more processors execute the instructions to:
apply the filter function one or more additional times on the data sensed by the elastomeric sensing device, wherein:
the filter function is performed with a different value of a variable each time the filter function is applied, and
the application of the filter function results in a respective level blurring effect of the combined image for each value of the different values of the variable; and
identify a value of the different values of the variable that results in an amount of blurring effect that corresponds to a filtration rule, wherein the combined image is generated using the different values of the variable that results in the amount of the blurring effect that corresponds to the filtration rule.

13. The non-transitory computer-related storage medium of claim 12, wherein the filtration rule identifies a range of light artifact uniformity of a resulting image, wherein the range of light artifact uniformity is associated with the resulting image corresponds to a threshold percentage of the pore spaces of the surface of the sample.

14. The non-transitory computer-related storage medium of claim 9, wherein the one or more processors execute the instructions to:
receive data sensed by the elastomeric sensing device, wherein the sensed data includes a plurality of images of the surface of the sample; and
generate one or more combined images from the data sensed by the elastomeric sensing device.

15. The non-transitory computer-related storage medium of claim 14, wherein the one or more combined images includes a depth image and an image of the surface of the sample.

16. The non-transitory computer-related storage medium of claim 9, wherein the one or more processors execute the instructions to:
compare image data associated with the one or more segmentation techniques to data indicative of at least one of depth or location of the pore spaces of the surface of the sample; and
identify that image data associated with a first segmentation technique of the one or more segmentation techniques corresponds to a threshold of a segmentation rule, wherein the image data is transformed into the binary image based on the image data being associated with the identification that the first segmentation technique of the one or more segmentation techniques corresponds to the threshold of the segmentation rule.

17. A system comprising:
an elastomeric sensing apparatus;
a memory; and
one or more processors that execute instructions out of the memory to:
access image data of a surface of a sample that includes pore spaces and portions of rock matrix, wherein the image data is associated with data acquired by an elastomeric sensing device,
apply one or more segmentation techniques on the image data based on the image data being associated with the data acquired by the elastomeric sensing device,
transform the image data into a binary image that separates the pore spaces from the portions of the rock matrix based on at least one segmentation technique of the one or more segmentation techniques, and
identify one or more petrophysical properties of the sample based on the binary image that separates the pore spaces from the portions of the rock matrix.

18. The system of claim 17, wherein the one or more processors execute the instructions to:
receive data sensed by the elastomeric sensing device, wherein the sensed data includes a plurality of images of the surface of the sample and each image of the plurality of images includes light effects associated with illumination provided by the elastomeric sensing device;
apply a filter function on the data sensed by the elastomeric sensing device to reduce the light effects associated with the illumination provided by the elastomeric sensing device; and
generate a combined image based on the application of the filter function that reduces the light effects associated with the illumination provided by the elastomeric sensing device.

19. The system of claim 18, wherein the illumination of each respective image of the plurality of images is provided at a different angle relative to a reference orientation of the sample.

20. The system of claim 18, wherein the one or more processors execute the instructions to:
apply the filter function one or more additional times on the data sensed by the elastomeric sensing device, wherein:
the filter function is performed with a different value of a variable each time the filter function is applied, and
the application of the filter function results in a respective level blurring effect of the combined image for each value of the different values of the variable; and
identify a value of the different values of the variable that results in an amount of blurring effect that corresponds to a filtration rule, wherein the combined image is generated using the different values of the variable that results in the amount of the blurring effect that corresponds to the filtration rule.
